(19) United States
(12) Patent Application Publication
(10) Pub. No.: US 2015/0211271 A1
(43) Pub. Date: Jul. 30, 2015

(54) BAND PROFILE FOR A DOOR FRAME

(71) Applicant: CDVI DIGIT, Pantin (FR)

(72) Inventor: Jacob BENHAMMOU, La Queue en Brie (FR)

(21) Appl. No.: 14/603,709

(22) Filed: Jan. 23, 2015

(30) Foreign Application Priority Data
Jan. 24, 2014 (FR) 14 00147
Jan. 24, 2014 (FR) 14 00148
Jan. 24, 2014 (FR) 14 00149
Jan. 24, 2014 (FR) 14 00150
Jan. 24, 2014 (FR) 14 00151
Jan. 24, 2014 (FR) 14 00152

(51) Int. Cl. E05C 19/16

(52) U.S. Cl. CPC E05C 19/166

(57) ABSTRACT

Band profile (3) for a system for opening/closing a door by means of an electromagnetic lock consisting of two elements, an electromagnetic suction pad (2) and a counter plate (1) made from a material that can be attracted by a magnet, the band profile being designed to be fixed to the openable part of the door to support at least one of the two elements of the lock and form a handle for opening the door, the band profile (3) having a transverse cross-section that is substantially in the form of a U comprising two lateral branches (32i, 32e) and a base (40) connecting the two branches and delimiting between them an inner space in which the two elements of the lock are received when the door is in a closed state, characterised in that on the outer surface of at least one of the lateral branches at least one gripping recess (4i, 4e) is formed.

The present invention relates to a band profile designed to be fixed to the openable part of a door, the opening/closing of which is performed by an electromagnetic lock, the band profile of one part receiving one of the two constituent elements of the electromagnetic lock (the electromagnetic suction pad and the counter plate made of a material attracted by magnet), preferably the counter plate, and the other part forming the door handle, whereas the other of the two elements of the electromagnetic lock, in particular preferably the suction pad, is fixed to the frame of the door. The present invention also relates to a device forming the door comprising an openable part and a door frame, a band profile of the above type being fixed to the openable part.

Band profiles of this kind are already known from the prior art. In general, the profile extends in a longitudinal direction corresponding to the vertical direction of the door and has a transverse section substantially in the form of a U comprising two lateral branches, generally forming an angle between them of between 0 and 90°, in particular about 45°, the two lateral branches being connected by a central base with which they define an interior space designed to receive the assembly of the elements of the electromagnetic lock when the lock is activated to close the door. The band profile also comprises a lower traversing inner web extending between the two lateral branches and which, on at least one section in the longitudinal direction of the profile, comprises an opening arranged to allow the passage of the element of the lock designed to be fixed to the profile, in particular the counter plate, and means for fixing said element, in particular the counter plate, to the profile projecting from at least one of the inner surfaces of the lateral branches comprising in particular an upper inner transverse plate extending between the two lateral branches or one or two edges projecting from one branch or two lateral branches.

Said profiles of the prior art have several disadvantages.

Said systems of the prior art are awkward to use, complicated to manufacture, in particular by injection moulding, including in particular the presence on the inside of the profile of an inner web or webs and/or edges to ensure the securing for example of the counter plate and not having sufficient security with respect to an attempted opening by force for example, in the knowledge that the closure by the effect of an electromagnetic suction pad can always be overcome theoretically by pulling the door with enough force to overcome the electromagnetic closing force, or with respect to the dismantling of the lock when the door is open.

The aim of the present invention is to overcome the disadvantages of the prior art by proposing a band profile designed to be fixed to the opening part of a door, which makes it possible to obtain a system for opening/closing the door which has greater manoeuvrability and/or greater security with regard to attempts to open it by force or dismantle it and/or is more simple to manufacture.

According to a first aspect of the invention, a band profile for a system for opening/closing a door by means of an electromagnetic lock formed by two elements, an electromagnetic suction pad and a counter plate made from a material which can be attracted by a magnet, for example a ferromagnetic material, the band profile being designed to be fixed to the openable part of the door to support at least one of the two elements of the lock and form a handle for opening the door, is as defined in claim 1.

In this way a greater degree of security is achieved, a malicious user will find it harder to hold the band for the purpose of increasing the pulling force needed to overcome the electromagnetic closing force. In particular, said arrangement of the profile is adapted effectively to form the band in such a way that it can be opened with two hands without making it easier to open the door by force.

According to a preferred embodiment, the dimension, form and geometry of the recess or each recess are such that the user only has available as a surface for the application of force for pulling the door towards him a surface which can only make contact with a surface smaller than that of the distal phalanges, in particular reduced by half, in particular the pressure application surface having a dimension in length of between 0.5 cm and 5 cm, preferably between 0.5 cm and 3 cm.

According to a particularly advantageous refinement, the dimension, form and geometry of the recess are such that the upper section forming the surface for the application of force by fingers for opening the door is inclined towards the bottom and towards the interior from the base, in particular at an angle of between 20° and 70°, preferably between 30° and 60°.

This inclination of the surface for the application of force prevents attacks using hooks in particular, for example for the purpose of pulling with a motor vehicle, as the band profile does not provide any holding point for the hook to attach to the band.

According to a second aspect of the invention, which itself forms an independent invention defined by the first aspect of the invention above, the band profile is as defined in claim 2.

According to the invention in particular, the transverse plate is fixed to the profile, and in particular to two branches or to at least one of the branches, independently of fixing the counter plate and/or the suction pad to the profile, and in particular the plate is secured independently of fixing the counter plate and/or the electromagnetic suction pad.

In this way a device is obtained which is much simpler to manufacture, particularly with respect to devices of the prior art in which for fixing the counter plate, in particular either a one piece transverse plate extending between the two lateral branches, or two edges each projecting from one of the branches were provided and a complex system for fixing the counter plate with locking bits sandwiching the edges, which in both cases in terms of manufacture, in particular by spinning or extrusion, made the production of the band profile particularly difficult to achieve.

According to a third aspect of the invention independent of the first and second aspects above, each taken independently or in combination with one another, the band profile is as defined in claim 3.

Clearly, in combination with the second aspect of the invention, the implementation of the system is much simpler. However, it is also possible to provide a transverse plate made in one piece with the profile and the previously cut out part of the upper base of the profile to insert the screw from above and thus secure the element of the lock by screw, in particular the counter plate, to the transverse plate then reseal the upper base. This type of procedure is less simple than one consisting of a combination of the second and third aspects of the invention. However, on its own it has the advantages of the third aspect of the invention and therefore forms part of the scope of protection conferred by this third aspect of the invention. Thus the screw is no longer visible on the lower face of the counter plate (or the suction pad if this element of the lock is fixed to the band profile) and the user, on opening the door and looking inside the band profile, only sees a flat surface corresponding to the lower face of the lock element, in particular the counter plate, without seeing a visible screw that he could unscrew to remove the element and thus deactivate the system for closing the door by electromagnetic lock. A system is obtained which much more secure against unlawful entry.

According to a fourth aspect of the invention, independent of the three aspects described above and forming an invention in itself independently of the three preceding aspects or simple or multiple combinations thereof, an assembly for opening/closing an access, comprising an openable part mounted movably relative to a door frame, the openable part, for example a door, can close the access defined by the door frame, for example the casing of the door, or open it, and a device forming an electromagnetic lock, comprising two elements, a counter plate and an electronic suction pad, one of the two elements being fixed to one of the openable part and the door frame and the other of the two elements being fixed to the other of the openable part and the door frame, is characterised in that shock absorbing means are provided for damping a shock applied to the openable part, in particular the door, in the opposite direction of the electromagnetic force attracting the two elements of the lock against one another, the arrangement being such that at least a portion of the force induced by the shock on the openable part does not affect the connection between the counter plate and the suction pad.

According to a preferred embodiment the assembly comprises a band profile with a longitudinal transverse section substantially in the form of a U comprising two lateral branches, internal and external branches respectively, and a base forming a peak extending between the two lateral branches, the band profile being fixed to the openable part, in particular a door, in particular to the edge of the opposite free end of the edge of the door by means of which it is fixed in a pivoting manner, one element of the two constituent elements of the electromagnetic lock, namely the counter plate and the electronic suction pad, being fixed to the band profile is characterised in that the arrangement is such that at least a portion of the force induced by the shock on the band does not affect the element of the electromagnetic lock fixed to the band.

The present invention, according to its fourth aspect, also provides a band profile according to claim 4.

In fact, to open the door by force overcoming the electromagnetic closing force, in the prior art it is sufficient to apply a force greater than the electromagnetic force for a brief moment, a standard “method” of opening the door by force consisting of applying a shock to the latter, i.e. an increased force for a brief period of time, for example in the form of a kick.

By providing such shock absorbing means according to the invention the electromagnetic closing force no longer takes responsibility for the first moments of application of an unlawful entry force and thus remains entirely in reserve for forces applied in a constant manner over a long period, said task being performed by the damping means which are better adapted to peaks of force of very short duration but high intensity which are more likely to reach the force necessary for overcoming the electromagnetic force but incapable of lasting for a long time. It is only after the damping action that the electromagnetic force comes into play, in the face of a force that is no longer at its peak. In this way a more reliable system is obtained.

Preferably, the damping means are formed by at least one sponge element made from a flexible material, in particular an elastomer.

According to another embodiment the damping means comprises a spring, in particular a helicoidal spring.

According to one embodiment, the band profile comprises a transverse plate extending inside the space defined by the two branches and from at least one of the branches, preferably from one branch to the other branch, one of the two elements of the electromagnetic lock being fixed to the transverse plate, and the damping means, in particular the sponge element made from a flexible material, in particular an elastomer, or the spring, being arranged between the transverse plate and the base.

In particular, the arrangement is such that during the application of a shock to the band, the damping means, at least for an interval of time, dampen the displacement of the band profile outside the element of the lock fixed to the band profile, whereas during said time interval the element of the lock secured to the band remains fixed.

According to a preferred embodiment, the damping means, in particular the sponge or the spring, are sandwiched between the transverse plate and a stop, for example in the form of a pressure plate, joined in displacement to the element of the lock, whereas the securing of the lock element to the transverse plate is performed in such a way that it enables a relative displacement between the plate and the lock element.

According to another embodiment the damping means, for example the sponge element or the spring, are arranged in the door frame, in particular below the element of the lock fixed to the door frame.

Preferably, the stop against which the damping means, in particular the sponge element or the spring, come into abutment is fixed to the element of the electromagnetic lock by a screw which passes freely into a hole traversing the transverse plate.

Preferably, the stop is designed in the form of a pressure plate. According to a fifth aspect of the invention, which constitutes an invention in itself independently of the four aspects of the invention described above or simple or multiple combinations thereof, the band profile is as defined in claim 5.

Preferably, the arrangement is such that the element of the lock fixed to the band profile can be displaced in an elastic manner towards the transverse plate by a distance between 1 mm and 7 mm, preferably between 2 and 5 mm under the effect of a force of 15 to 20 Newtons, in particular by compressing the elastic means tending to push away the element of the transverse plate, for example by compressing an elastomer sponge arranged between the element of the lock and the counter plate.

By providing said elastic means, which for example according to a first embodiment can have the form of a sponge made from an elastomer material or, according to another embodiment, the form of a spring arranged in a cavity formed in the counter plate, it is ensured that each counter plate of the plurality of at least two counter plates is repelled effectively downwards and it is thus ensured that the at least two counter plates are each always positioned perfectly relative to the respective electronic suction pad, avoiding by means of the automatic centring performed by the elastic means, any play between each counter plate and its suction pad which is not very favourable for good cooperation by magnetic attraction of the suction pads and the counter plates, for example in cases where the doors are not perfectly flat or the walls are not perfectly flat.

In this way a more secure system is obtained which in particular is more difficult to open by force, ensuring that the different interactions of the counter plates-suction pads which extend in the length direction of the profile all function in an optimum manner, and in particular without one or more of them being made ineffective by poor alignment relative to other counter plate-suction pad pairs.

According to a sixth aspect of the invention, independent of the five aspects described above as well as simple or multiple combinations thereof, which constitutes an invention in itself, the band profile is as defined in claim 6.

In particular, the counter plate of the electromagnetic lock is fixed to the inside of the band.

According to one embodiment, the light source is received in the suction pad of the electromagnetic lock, the arrangement being such that when the door is closed the suction pad is received in the band profile and the light emitted by the light source of the suction pad is propagated by the end plug or plugs and gives an indication of the open/closed state of the door.

In this way a more reliable system is obtained. During his rounds a guard can easily tell from a distance whether the door has been closed properly and/or can see the activated state of the electromagnetic system, whereas current systems make it necessary for him to check “manually” that the door is closed properly and go up to said door and come back, whereas by means the invention this unnecessary back and forth movement is avoided.

Each of the six aspects of the invention described above forms a separate invention. However, obviously the features of each one can be combined with those of any other one or a plurality of others to form advantageous embodiments which form part of the scope of protection of the present invention.

According to an advantageous embodiment a gripping recess is provided in each of the lateral branches.

Preferably, the dimension, form and geometry of the recess or each recess are such that the user only has available as a force application surface for pulling the door towards him a surface which can only make contact with a surface smaller than that of distal phalanges, in particular reduced by half.

In particular, the surface for the application of force has an extension of between 0.5 cm and 5 cm, preferably between 0.5 cm and 3 cm.

Preferably, the dimension, form and geometry of the recess are such that the upper section forming the surface for the application by the fingers for opening the door is inclined downwards and towards the interior from the base, in particular at an angle between 20° and 70°, preferably between 30° and 60°.

According to an advantageous embodiment, each lateral branch comprises a first lower section that is substantially straight respectively, then after this respective straight section a respective lower curved section, the concavity of which is turned towards the inside of the profile, followed by a respective substantially straight intermediate section inclined in relation to the straight lower section to the inside of the profile, then from said straight intermediate section an intermediate curved section the concavity of which is turned towards the outside of the profile, followed to the top by a substantially straight upper section.

In particular, the lock element fixed to the band is the counter plate.

Preferably, the transversal plate extends from one of the branches to the other.

According to a preferred embodiment the upper base is made in one piece with the two lateral branches and the transverse plate is separate from the part of the profile with which the base and the branches form one piece.

According to one embodiment, the transverse plate is fixed to the part of the profile with which the base and the lateral branches are in one piece (that is by moulding with the latter) by non-reversibly clipping its ends into the clipping cavities arranged on the respective inner surfaces of the lateral branches.

According to another embodiment, the transverse plate is in one piece with the lateral branches (that is by moulding with the latter) and the upper base forms part of an element in the form of a hat which is fixed to the lateral branches, in particular by screwing, clipping, clicking or the like, in particular in a non-reversible manner.

In particular, according to a preferred embodiment, one of the two elements of the electromagnetic lock, in particular the counter plate, is fixed to the transverse plate by screwing at least one screw with a rod and a head projecting laterally from the rod, the head of the screw being located above the transverse plate between the latter and the upper base of the profile.

According to one embodiment a sponge element made from a flexible material, in particular an elastomer material, is arranged between the transverse plate and the upper base.

Preferably, the end of the rod opposite the head is received in a blind bore opening to the upper surface of the element of the lock, in particular the counter plate.

According to a preferred embodiment, the band profile comprises a lower intermediate plate extending from one of the lateral branches of the U up to the other lateral branch of the U, the intermediate transverse plate comprising an opening in a substantially complementary form, for example rectangular, to the cross sectional form of the counter plate to enable the passage of said counter plate in the direction of the upper transverse plate.

Preferably, the dimensions of the opening formed in the lower plate are substantially identical to the transverse dimension of the counter plate, such that the lower face of the counter plate is substantially flush with the level of the edge of the opening defined in the lower intermediate plate when the counter plate is fixed to the transverse plate.

Preferably, the sponge element is sandwiched between the transverse plate and the head of the screw, possibly with the interposition of a pressure plate.

More preferably, the part of the profile comprising the base is a distinct part of the transverse plate.

Preferably, the sponge damping element is arranged between the transverse plate and a pressure plate that is more rigid than the sponge element.

More preferably, at least one screw ensures the securing of the element of the lock to the counter plate, the screw having a head and a rod, the sponge element being sandwiched between the transverse plate and the head of the screw, with the possible interposition of a pressure plate.

Preferably, the pressure plate, the sponge and the transverse plate are traversed by the at least one rod and the head holding the pressure plate against the sponge.

According to an advantageous embodiment, the elastic means are formed by a sponge made of an elastomer material.

According to an advantageous embodiment, the elastic means comprise a spring.

Preferably, the spring is received in a cavity formed in the element of the lock fixed to the band.

In particular, the element of the lock fixed to the band is the counter plate.

According to an advantageous embodiment, the element of the lock is fixed to the transverse plate by at least one screw, the elastic means being arranged between the element of the lock and the transverse plate.

Preferably, the head of the at least one screw is located on one side of the transverse plate whereas the elastic means are arranged on the other side of the plate.

The present invention also relates to a system for closing/opening a door, comprising an openable part, for example a door, to which a band profile according to the invention is fixed and a door frame, for example a door casing, to which the other element of the electromagnetic lock is fixed which is not secured to the band profile.

By way of example only, preferred embodiments of the invention are described in the following with reference to the drawings in which:

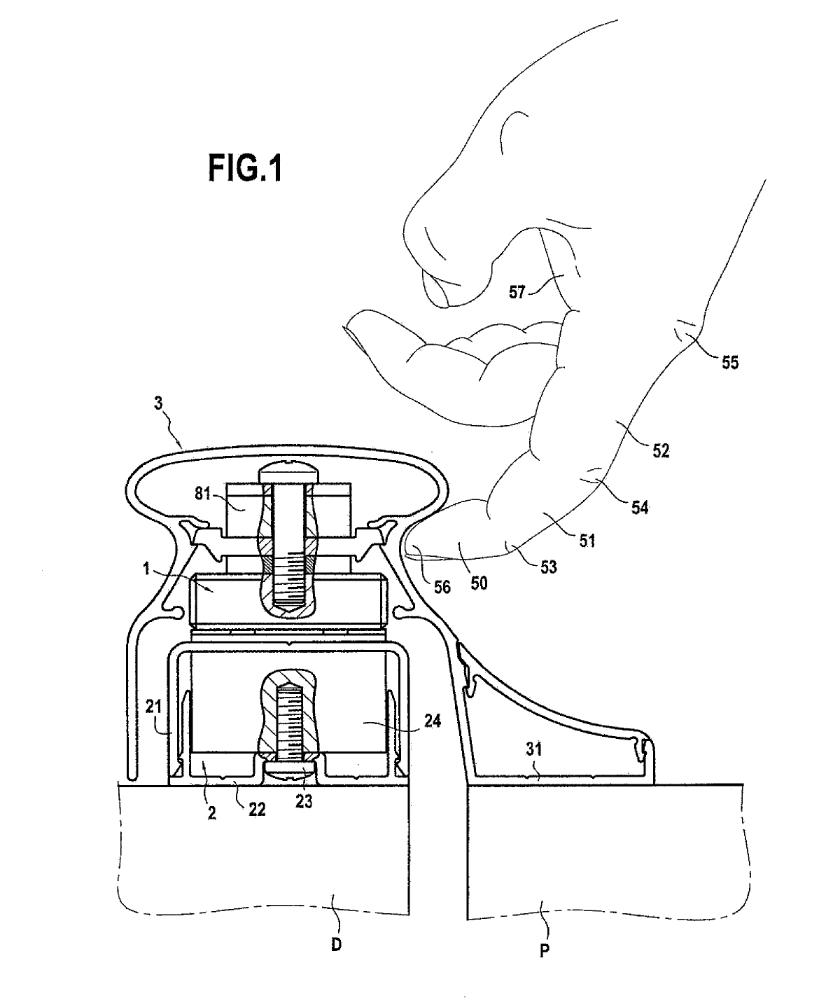

FIG. 1 is a transverse cross section, i.e. perpendicular to the vertical axis or longitudinal axis, of the band profile, the cross section being made at the point where two elements of the electromagnetic lock are located which cooperate with one another to perform the closure, namely, the counter plate and the electronic suction pad;

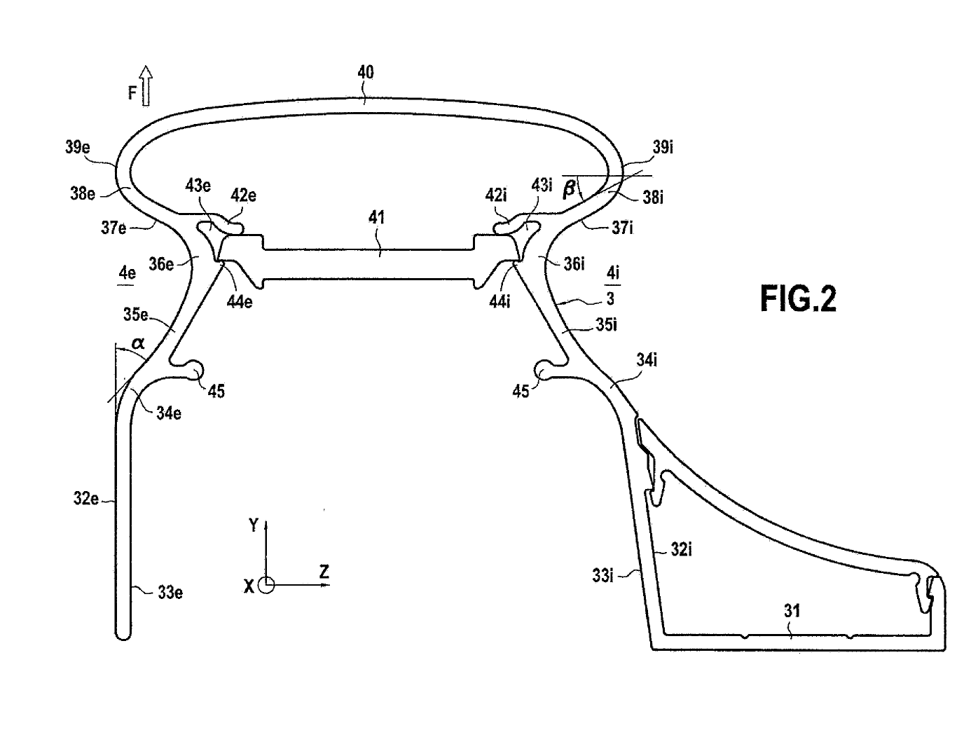

FIG. 2 is a view identical to FIG. 1 of the band profile alone, i.e. without the elements of the electromagnetic lock and without the openable part and door frame;

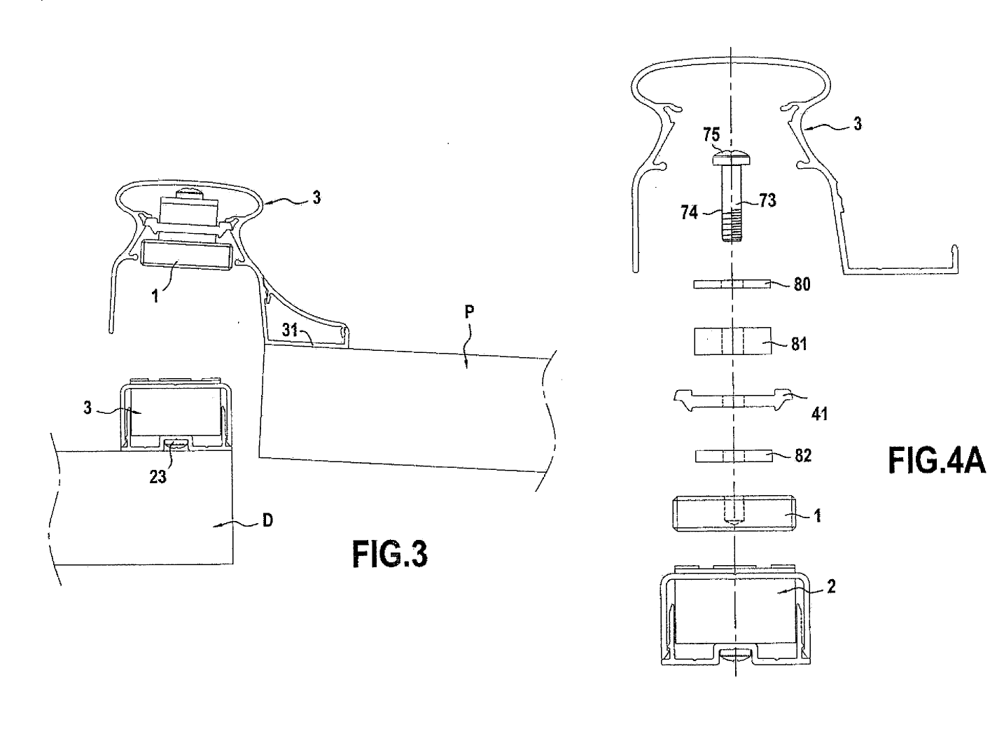

FIG. 3 represents an assembly forming an electromagnetically controlled door comprising a band profile, as described in FIGS. 1 and 2;

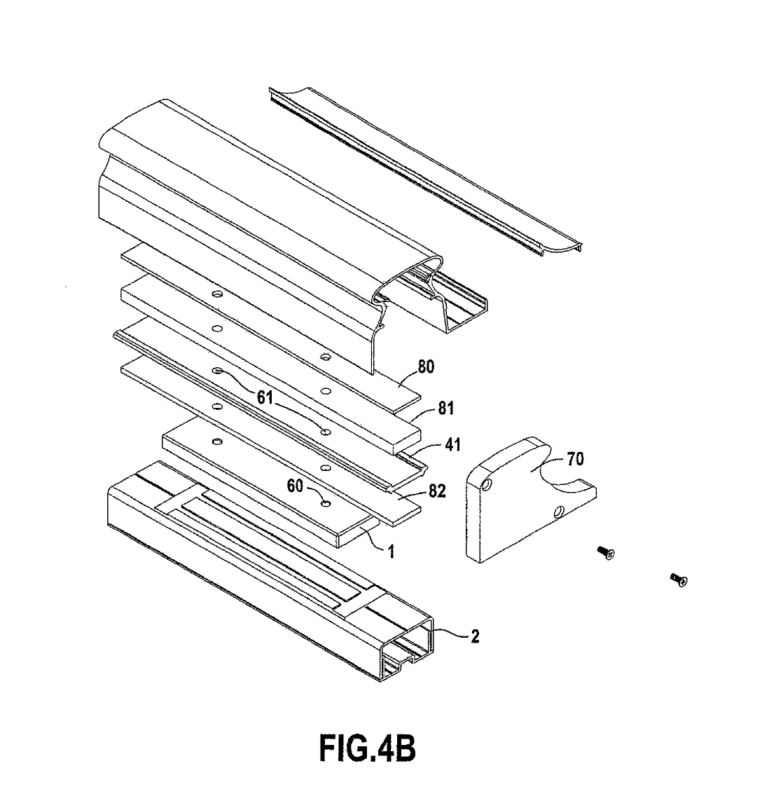

FIG. 4a is an exploded cross section of the profile of FIGS. 1 to 3;

FIG. 4b is an exploded perspective view according to a first axis of the band profile of the preceding figures;

FIG. 4c is an exploded perspective view of the band of FIG. 4b according to another axis;

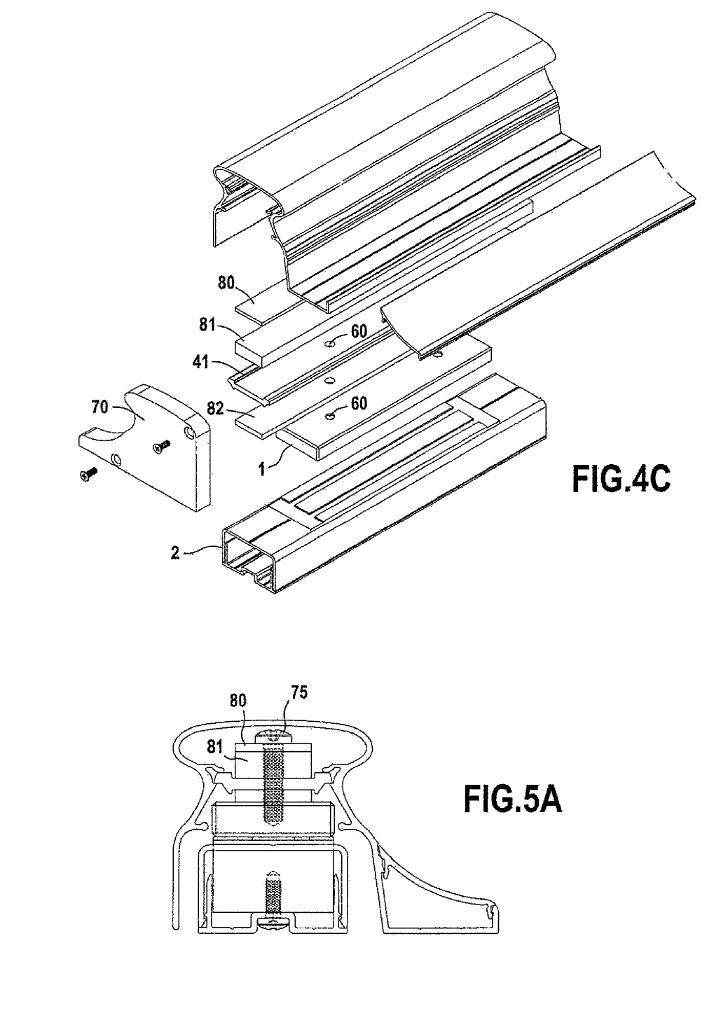

FIGS. 5a, 5b and 5c are equivalent views to the views of FIGS. 4a to 4c in the assembled state;

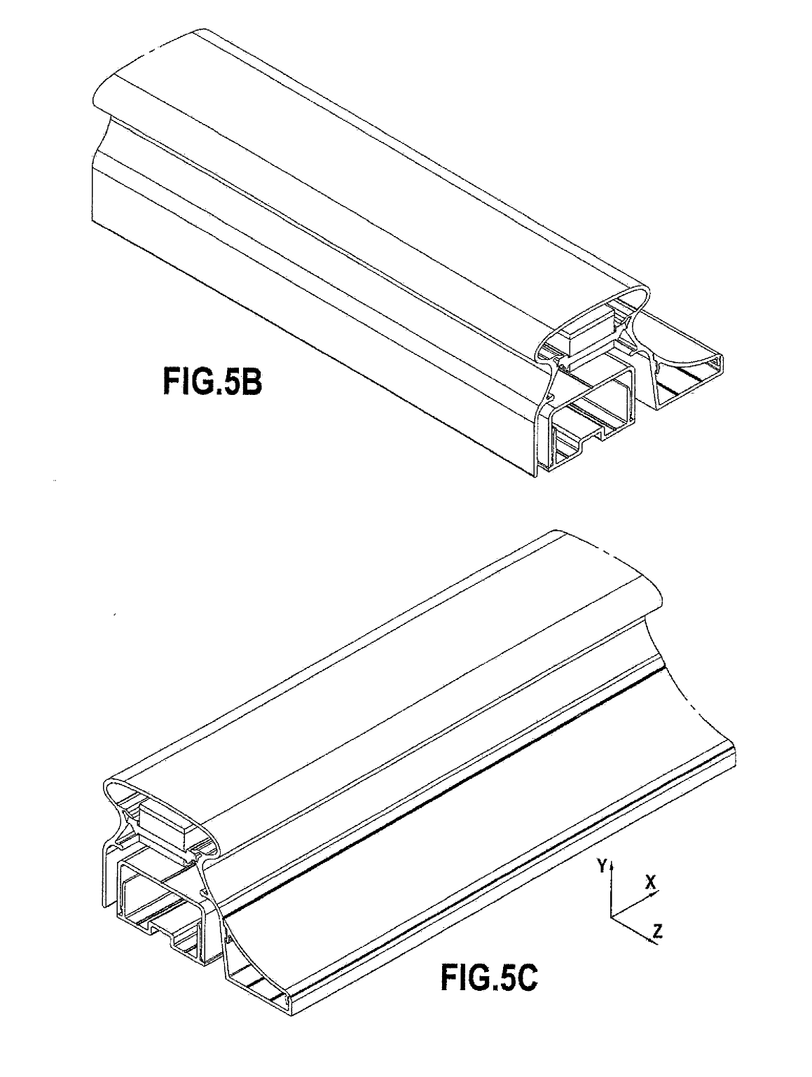

FIG. 6 is a perspective view of the band profile of FIG. 2; and

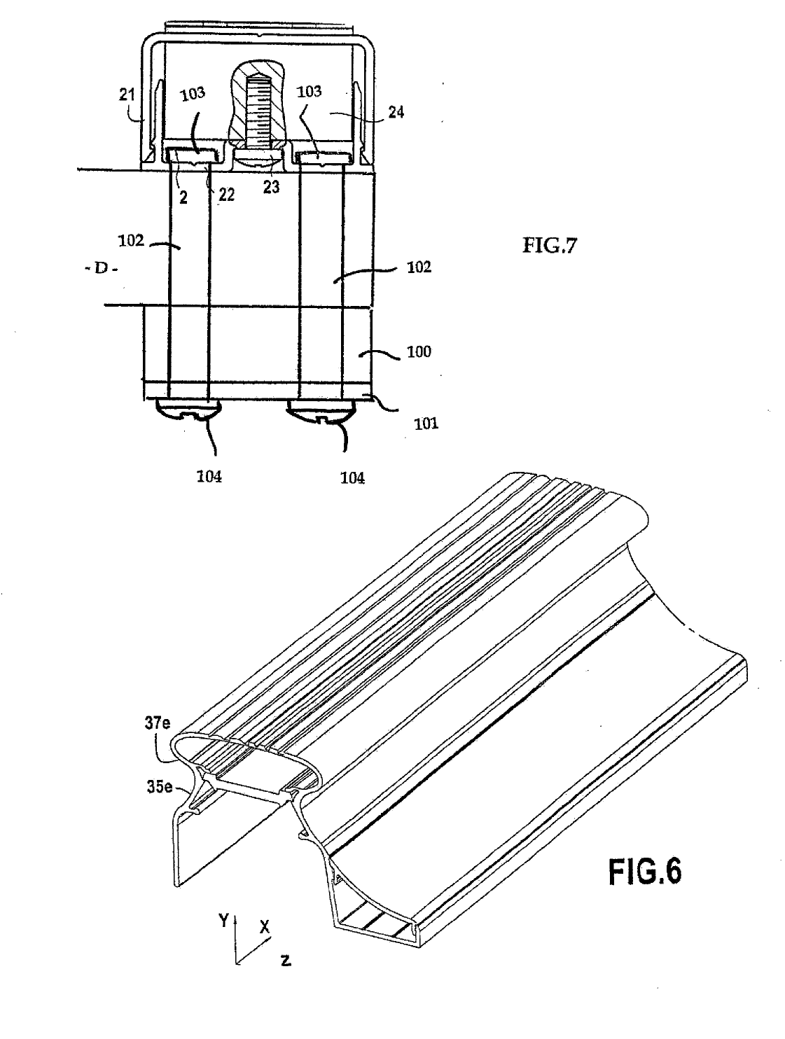

FIG. 7 represents part of the side of the door frame of another embodiment of an assembly forming an electromagnetically controlled door.

The figures show a system for closing a door by means of an electronic lock formed by a counter plate 1 with a generally simple parallelepiped rectangular form and made from a material which can be attracted by magnet and a suction pad 2, generally with a substantially parallelepiped rectangular form formed by two profiles 21 and 22 in a U shape fitting into one another and receiving therein an electromagnet 24 with a prismatic shape and means for its activation such that when the electromagnet is deactivated (by a not shown electronic circuit connected for example to the button for opening the door or to a detection sensor of a magnetic card enabling access) it does not create a magnetic field and does not attract the counter plate, and reciprocally in the activated state the electromagnet creates a magnetic field which attracts the counter plate thus creating a closing force for the door.

Generally the electronic suction pad 2 is formed by two profiles 21 and 22 in the form of a U, upper and lower profiles that fit into one another in particular by clipping to form that which is commonly referred to as a “technical post” in which the electromagnet 24 with a prismatic form is mounted. The two profiles are screwed by a screw 23 to the electromagnet 24 with a prismatic form. The technical post is fixed, in particular by means of one or a plurality of screws, to the door frame D of the door, in particular along the casing of the latter.

The counter plate 1 is fixed to the band profile 3 itself fixed by an outer web 31 to the openable part, here a door P, adjusted to the casing of the door frame D. The securing of the band 3 to the door P is generally performed by screwing the web 31 to the vertical free edge of the door P. The band profile 3 extends in longitudinal direction which corresponds to the upright of the door. The section transverse to the longitudinal direction of the band 3 is shown in FIGS. 1, 2, 3, 4A and 5A. Said cross section is formed according to the cross-sectional planes through which the elements of the electromagnetic lock pass, namely the counter plate and the suction pad.

Several pairs of suction pads 2 and associated counter plates 1 can be arranged at a distance from one another in length direction (X axis defined in FIG. 2 as being the direction perpendicular to the plane of figure) on the inside of the band profile.

The band profile 3 has a longitudinal transverse cross section substantially in the form of a U comprising two lateral branches 32e, 32i and an upper base 40. In the present application, the top and the bottom are defined as being the top and bottom of the figures showing the profile, i.e. in particular the top and bottom in FIG. 2. The bottom of the profile is located on the side of the door and the top of the profile on the side opposite the door. The top and bottom are defined along the Y axis in the figure.

The upper base 40 extends between two end points 39e and 39i external and internal end points, the internal end being from the side of the door and in particular of the securing web 31 and external end being from the opposite side to the door (the external side is the left side in FIG. 2 and the internal side is the right side in FIG. 2).

The two side branches 32e and 32i extend respectively up to the base 40 by joining together at the respective end points 39e and 39i.

In longitudinal transverse cross section, each lateral branch 32e and 32i comprises a first lower section 33e and 33i that is substantially straight respectively, the two sections being substantially parallel, but can form between then an angle which can theoretically be up to almost 90°, in practice about 30°, in the figure about 10°. Following this respective straight section 33e and 33i, each branch comprises a curved lower section 34e and 34i respectively, the concavity of which is turned towards the inside of the profile, followed by a substantially straight respective intermediate section 35e and 35i inclined relative to the lower straight section 32e and 32i towards the inside of the profile at an angle α (measured in the trigonometric sense in FIG. 2) strictly greater than 0° and less than or equal to 90°, in particular between 30° and 60°. Following this intermediate straight section 35e and 35i there is a curved intermediate section the concavity of which is turned towards the outside of the profile, followed towards the top by an upper substantially straight section 37e and 37i. This respective upper section 37e and 37i, as shown in the figures can be inclined relative to the horizontal, here defined as being substantially the plane of the door and in particular the plane of the web 31 and in particular the axis Z in FIG. 2.

If the upper straight section 37e and 37i is inclined relative to the horizontal, the angle β (measured in the trigonometric sense in FIG. 2) is strictly greater than 0° and strictly less than 90°, and it can be in particular between 30 and 60°.

However, it should be noted that according to the present invention, this upper straight section 37e and 37i cannot be inclined relative to the horizontal without departing from the general scope of the invention.

The straight section 37e and 37i is continued by a curved section 38e and 38i the concavity of which is turned towards the inside of the profile and which extends up to the respective end point 39e and 39i of the base 40.

The base 40 can be curved as shown in FIG. 2, in particular having a substantially ovoid form between its two end points 39e and 39i. It is also possible to provide a central straight form terminated at the two sides by curved forms, for example in the form of an arc of a circle, in particular in continuation of the curve with the sections 38e and 38i of the lateral branches 32e and 32i.

The sections 35e, 36e, 37e, respectively 35i, 36i, 37i form respective recesses 4e, 4i on the surface of the profile which are designed to receive at least part of the hand of the user to allow him to apply a pulling force F to open the door.

The respective section 37e and 37i forms a surface for the application of pulling force F by the user to pull the door towards him and open it. To achieve this he positions at least the internal face (palm side) of the distal phalange of his respective hand (left or right on the bearing surface formed by the respective section 37e and 37i).

When the distal phalange 50 is flat against the application surface with the distal portion 56 of the finger in contact with the base of the recess 4e, 4i and the palm 57 of the hand is oriented substantially perpendicular to the plane of the door to be opened, none of the intermediate and proximal joints 54 and 55 of the finger or fingers of the hand are located closer to the door than the distal joint 53. Moreover, the two intermediate 51 and proximal 52 phalanges are each closer to the user (or more remote from the door) than the distal phalange 50.

Thus, by means of this arrangement of the handle of the door, the user cannot apply a large force for pulling the door and in particular for trying to open it by force, knowing that when the lock is deactivated there is no need to use a large force to open the door.

Preferably, the length over which the section 37e, 37i forming the surface for the application of force extends is shorter than the length over which the two distal 50 and intermediate 51 phalanges extend. Even more preferably, said length of the application face is substantially equal to the length of the distal phalange. Even more preferably, it is shorter than the length of the distal phalange 50, even more preferably shorter than or equal to half of the length of the phalange.

In this latter case, it is not necessary for the section 37e and 37i to be inclined towards the door from the end point 39e, 39i of the base 40 and it can have any orientation relative to the horizontal (the angle β can be zero or less than zero), knowing that with such a dimension of the face for the application of force there is no area in the recesses 4e-4i below the face 40 enabling the fingers to take hold and build up a significant force. When a user puts his fingers in contact in the recess 4e, 4i it is not possible for him to really retract them to ensure a significant hooking force and therefore he cannot try to build up a significant force which could be used to open the door by force by applying a mechanical pulling force to the band that is greater than the electromagnetic force ensuring the electromagnetic connection between the counter plate and the electromagnet of the suction pad 2.

By thus providing no way of forming an attachment it is possible, as also shown in different figures showing the band profile 3, to make the band symmetrical in its upper part and in any case having a form enabling it to be held by the left hand or the right hand or both at once to pull the door towards the user. Said band is thus more manoeuvrable than those of the prior art. However, owing to the arrangement of the sections defining the recesses 4e, 4i forming the handle, two persons each using both hands, one on the external recess 4e, the other on the internal recess 4i, said two persons being of average strength, the latter are not able to build up a force that is sufficient for opposing the opening of the door for a standard electromagnet, i.e. an electromagnet that builds up an electromagnetic force of between 10 N and 5000 N, in particular between 500 N and 5000 N.

An intermediate plate 41 extends between the two lateral branches 32e, 32i, substantially in horizontal direction (direction Z in FIG. 2). It extends from one branch to the other. The transverse plate 41 extends between the two branches 32e, 32i substantially at the level where the two branches are closest to one another, i.e. substantially at the level of the curved sections 36e, 36i.

Two elastic lips 42e, 42i project from the respective inner face of the branches 32e, 32i of the profile and define respective grooves 43e, 43i for receiving the two ends of the transverse plate 41. Two stops 44e, 44i are formed at the lower edge of each groove 43e, 43i to enable the clipping of the ends in the form of a lip of the transverse plate 41 into the cavities in such a way that prevents subsequent removal, the elastic lips pushing the plate downwards against the stops 44e, 44i.

According to another embodiment, it is possible for the receiving and securing cavities of the intermediate plate to be formed at the respective ends of edges emerging from the inner face of the profile and extending partially inside the profile in the direction of one another or the other cavity.

Thus, the transverse plate 41, to which the counter plate 1 is designed to be fixed, in particular by screwing, is a separate part from the rest of the band profile 3 and in particular of the part of the band profile comprising the upper base 40. Furthermore, the band profile 3 comprises a lower intermediate plate 45 extending from one of the lateral branches of the U up to the other lateral branch of the U. Said transverse plate 45, at the point where the counter plate is received, is recessed (as shown for example in FIG. 2 where it can be seen that the plate 45 is formed by two end parts separated by a space which enables the passage therein of the counter plate). At the point of a longitudinal section where there is no counter plate, the plate 45 extends continuously from one of the branches of the profile to the other. Thus, in said plate 45 openings are defined with a substantially complementary shape (for example rectangular) to the cross-sectional form of the counter plate to enable the passage of said counter plate 1 in the direction of the upper transverse plate 41. Preferably, the dimensions of the openings formed in the lower plate 45 are substantially identical to the transverse dimension of the counter plate such that its lower face is substantially flush with the edge of the opening defined in the lower intermediate plate 45 when the counter plate is fixed to the upper intermediate plate 41. In this way it is not possible to take hold of it to tear the plate when the latter is fixed inside the band 3 to the upper plate 41.

Means are provided for fixing the counter plate to the profile band 3. Apart from the intermediate plate 41 and the clipping system with lips 42e, 42i and stops 44e, 44i, said fixing means also comprise two screws 73 (only one is shown in FIG. 4A, but as shown in FIG. 4B for example each element designed to be traversed by a screw to be fixed to the plate 41 comprises two holes for the passage of a screw 73). The screw 73 comprises a threaded rod 74 and a head 75 projecting laterally from the rod 74. The counter plate 1 comprises two blind tapped bores which the respective screws 73 enter to be screwed there. Furthermore, the intermediate plate 41 comprises two holes 61 designed to correspond with the holes 60 for enabling the passage therein of the rod 74 of respective screws. In this way the securing of the counter plate 1 is ensured by screwing rods 74 of respective screws 73 into respective blind bores 60 of the counter plate 1.

The embodiment represented in the figures shows refinements which in themselves form a separate invention and which also assist with the securing function sought by the present invention.

A first effect of securing associated with the securing method described above is that the head of the screw 75 is located on the inside of the band 3 between the upper base 40 and the upper intermediate plate 41, such that in the open state of the door, when a person is looking inside the band profile, he only sees a substantially smooth surface formed by the lower face of the counter plate 1 and the remaining inner face of the lower intermediate plate 45. There is no visible screw that a malicious user could try to unscrew to disconnect the counter plate from the door and thus deactivate the function of the electromagnetic lock of the door.

Furthermore, between the head of the screw 75 and the plate 41 a sponge 81 is arranged made at least of a flexible material, preferably an elastomer material, for example alveolar rubber and a metal pressure plate 80. The sponge 81, with a rectangular parallelepiped form (but it could have any other form in volume) and the pressure plate 80 are also pierced with holes equivalent to hole 60 to enable the passage of the screw or screws 73. The screwing of the screw or screws 73 into the counter plate 1 is performed in such a way as to ensure that the sponge 81 is held in position by the plate 80, preferably without crushing the sponge 81.

Thus the pressure plate 81, the screws 73 and the counter plate I are fixed in a connected manner, the displacement of one involving the displacement of the other.

In contrast the holes 61 through which the rods 75 of the screws 73 pass into the intermediate plate 41 are neither threaded nor tapped, such that the passage of the rods into said holes is free, which enables the mutual connection of the counter plate and the intermediate plate with the possibility of a relative displacement of the intermediate plate relative to the counter plate.

When a sudden blow or shock is applied to the band profile towards the top of FIG. 1, i.e. in opposite direction of the electromagnetic force attracting the counter plate against the suction pad, the transverse plate is moved upwards and presses the sponge 81 against the pressure plate. The presence of this shock absorbing element 81 in the form of a sponge made of flexible material, preferably elastomer material, has the advantage, for an electromagnetic lock, the magnetic closing force of which is determined in advance, of increasing the force required to force the door open, in particular in cases where malicious opening is performed by creating a shock, for example a kick. In fact, the action of a large force for a short period likely to open the door with this sudden blow is transmitted to the sponge 81, which, under the effect of the pressure plate which comes closer to the counter plate under the effect of the blow, is compressed and dampens the shock, without the latter being transmitted to the interface between the counter plate-suction pad, and therefore without any force being provided against the magnetic force of attraction. This ensures that it is necessary to provide a force that is not just very high but of long duration to be able to force the door, thus improving the security of the door against opening by force.

It should be noted that in this embodiment, the head 75 of the screw does not bear directly against the intermediate plate 41 but with the interposition of the sponge 81 and the pressure plate 80. However, according to a much less advantageous embodiment, but also implementing the third aspect of the invention, the head of the screw can bear directly on the transverse plate in order to fix the counter plate to the transverse plate.

Underneath the transverse plate 41 and between said plate 41 and the counter plate 1 elastic restoring means are arranged, here in the form of a sponge 82 made from an elastic or elastomer material, which are arranged in such a way as to push downwards, i.e. outside of the opening formed in the plate 45, the element of the electromagnetic lock supported by the band, i.e. in the embodiment shown in the figures, the counter plate 1.

Said returning or thrust force of the counter plate 1 in the direction of the suction pad 2 has the effect of partly pushing the counter plate 1 against the suction pad 2 and thus compensating any differences in the distance between two suction pad-counter plate pairs arranged at a distance from one another and following one another in the longitudinal direction of the profile. In fact most frequently when the profile comprises a plurality (generally three) pairs of counter plate-suction pads at a distance from one another along the longitudinal direction of the profile, it is fairly often the case that the relative positions of the counter plate-suction pad vary from one pair to the other (for example as a result of manufacturing tolerances of the counter plate or the suction pad, or as a result of the imperfect flatness of the door and/or the openable part) which causes one couple, once in a position of attraction to the other, to totally or partially nullify the action of attraction in the other couple by preventing it from approaching the other one sufficiently. The presence of said elastic return means, in particular in the form of a sponge 82, ensures an auto-alignment function so that all of the pairs of counter plate-suction pads are in perfect contact with one another. In this way a more secure system is obtained in particular which, for the given specifications of the electromagnetic locks used, optimises or maximises the force of the lock which has to be overcome during an attempt to open by force.

Preferably, the arrangement is such that the counter plate 1 can be displaced in an elastic manner towards the transverse plate 41 by a distance of between 1 mm and 7 mm, preferably between 2 mm and 5 mm by the compression of the sponge 82 under the effect of a force of 15 to 20 Newtons, the force being characteristic of the torque exerted by a standard self-closing door.

The return means are shown in the figures by an elastomer sponge. The latter could also have another form, in particular a spring, especially a helicoidal spring arranged in the blind bore of the counter plate receiving the rod of the screw.

At the two longitudinal ends of the band profile 3, plugs are also provided made from a transparent or translucent material. Said plugs have the form of a plate and are fixed by screws 80 to the band profile. They could have other forms, the essential feature being that at least a portion of the plug emerges on the outside of the band profile.

The plugs are secured such that at least a portion of the latter is located on the outside of the profile. They are arranged in the technical post fixed to the casing of light sources 81 which are visible when the door is open. When the door is closed and the electronic suction pad is covered by the band profile, the light sources are located opposite plates forming luminous plugs which, in particular from the effect of the wave guide, transmit light and thus enable the user to see said light, in particular its colour, if a plurality, in particular two, colours are provided to indicate different states of the electromagnetic lock, such as activated or non-activated. The user can thus easily recognise the state of the lock without having to open the door to check the suction pad, the state of the latter can be seen at a distance and even when the door conceals the technical post. The emerging part of the plugs made of translucent material ensures the guiding of light emitted by the light source arranged inside the profile and makes it possible to create a sort of light band above the band or below which is/are visible at a distance from the door.

FIG. 7 shows another embodiment of an opening/closing assembly of an access, comprising an openable part (not shown), mounted movably in relation to a door frame, the casing D of the door, the door being able to close the access defined by the casing or open it, and an electromagnetic lock, comprising a counter plate (not shown) identical to the counter plate 3 and an electronic suction pad identical to suction pad 2, the counter plate being fixed to a band profile (not shown) and the suction pad to the casing D. The band profile can be that of the other figures or can be different from the latter.

In this embodiment, the means are provided for absorbing a shock applied to the openable part, for example a kick in the opening direction of the door, namely in FIG. 7 from the bottom to the top. Said damping means comprise a sponge 100 made from a flexible material, preferably an elastic or elastomer material, arranged below the door frame (i.e. the side opposite the direction in which the door opens), between the door frame and a pressure plate 101. Two screws 102 traverse the pressure plate 101, the sponge 100, the door frame D and the profile 21 of the suction pad to cooperate with two respective nuts 103 on the inside of the suction pad. Corresponding holes are formed in the plate 101, the sponge 100, the door frame D and the profile 22 in a U shape of the suction pad. The holes in the door frame do not comprise a tapping or thread, such that the door frame can slide along the rods of the screws 102. In contrast, at least the profile 22 is joined in movement by screwing screws 102 into associated tappings with the screw 102.

The pressure plate is sandwiched between the sponge 100 and the heads 104 of the screws 102. The sponge 100 is sandwiched between the pressure plate 101 and the door frame D.

Thus when a shock, for example a kick, is applied to the door, the suction pad is driven by the local displacement of the counter plate (joined to the band profile, itself joined to the door) and moves away from the door frame, causing a corresponding compression of the sponge 100, which thus dampens the shock, without the force of the latter being able to act, at least to some extent, to move apart the counter plate and the suction pad. According to the compression of the sponge, the suction pad 2 moves away from the door frame, with the counter plate, such that the shock does not have an effect on the connection of the counter plate-suction pad.

Instead of an elastic sponge 100 it is possible to provide one or more springs, in particular helicoidal springs mounted around the rods of screws 102 and abutting between the door frame and the plate 101.

In the embodiment described in FIG. 7, the damping means are arranged in the door frame. In the embodiment of the other figures, the damping means are arranged in the openable part, in particular in the band profile.

It is also possible to provide a combination of these two solutions with a plurality of damping means, in particular in the band connected to the openable part and in the door frame. Furthermore, any technical feature described above in connection with the embodiment of FIGS. 1 to 6 can be provided in the embodiment of FIG. 7 or in combination therewith.

In the embodiments described in the figures, the counter plate is fixed to the band profile fixed to the openable part and the suction pad fixed to the door frame. However, without departing from the scope of the present invention it is possible to reverse the positions of the counter plate and the suction pad, and in particular fix the suction pad to the transverse plate of the band profile and the counter plate to the door frame.

1. A band profile (3) for a system for opening/closing a door by means of an electromagnetic lock which consists of two elements, an electromagnetic suction pad (2) and a counter plate (1) made from a material that can be attracted by a magnet, the band profile being designed to be fixed to the openable part of the door to support at least one of the two elements of the lock and form a handle for opening the door, the band profile (3) having a transverse cross-section which is substantially in the form of a U comprising two lateral branches (32i, 32e) and a base (40) connecting the two branches and delimiting thereby an interior space in which the two elements of the lock are accommodated when the door is in a closed state, characterised in that on the outer surface of at least one of the lateral branches at least one gripping recess (4i, 4e) is formed, each gripping recess being delimited in longitudinal transverse cross-section by at least two sections, a lower and upper section, of the outer surface of the profile, the upper section (37i, 37e) forming a surface for the application of force on the profile by the user towards him for opening the door, the form, dimension and geometry of the upper section being such that when the user positions the inner surface of at least one end or distal phalange, in particular the distal phalanges, of the hand flat on the upper section until the edge (56) of the or each distal phalange is in contact with the lower section (35i, 35e), whereas the palm of the hand is arranged substantially perpendicular to the door, the phalanges, the proximal (52) and intermediate (51) intermediate phalanges respectively of the finger of the distal phalange (50) or each distal phalange, are more remote from the door than the respective distal phalange (50).

2. The band profile of claim 1 further comprising a transverse plate (41) extending inside the space defined by the two branches and the base between the two branches and at least from one of the branches, preferably from one of the branches to the other, one of the two elements of the electromagnetic lock, in particular the counter plate (1), being fixed to the transverse plate, in particular by screwing, characterised in that the part of the profile comprising the base (40) is a distinct part of the transverse plate (41).

3. The band profile of claim 2 further comprising at least one screw (73) having a rod (74) and a head (75) projecting laterally from the rod, characterised in that the head (75) of the at least one screw is arranged above the transverse plate between the latter and the upper base of the profile.

4. A band profile having a longitudinal transverse cross section substantially in the form of a U comprising two lateral branches (32i, 32e) internal and external branches respectively and a base (40) forming a peak extending between the two lateral branches, the band profile being designed to be fixed to an openable part, in particular a door, in particular at the opposite end free edge on the edge of the door by means of which it fixed in a pivoting manner, one of the two constituent elements of an electromagnetic lock, namely the counter plate (1) and the electromagnetic suction pad (2), being secured to the band profile (3), characterised in that shock absorbing means are provided which are designed to dampen a shock applied to the band in the opposite direction of the electromagnetic closing force, the arrangement being such that at least a portion of the force induced by the shock on the band does not affect the element of the electromagnetic lock fixed to the band.

5. The band profile of claim 2 further characterised in that at least two lock elements are provided, in particular at least two counter plates (1), arranged one after the other in the longitudinal direction of the band at a distance from one another, each of the at least two elements being fixed by its own securing means (73) to the band and the securing of each element of the lock to the band profile is such that it is mobile in relation to the transverse plate under the effect of thrust, in particular in an elastic manner.

6. A band profile (3) having a longitudinal transverse cross section substantially in the form of a U comprising two lateral branches (32i, 32e) internal and external branches respectively and a base (40) forming a peak extending between the two lateral branches, characterised in that at least one of the two longitudinal ends of the band profile, preferably at both longitudinal ends, at least one end plate (70) is provided forming a plug, ensuring the closure of the inner space defined by the band at the top and/or the bottom, the or each plug comprising a part extending beyond the band profile made of translucent material so as to create at least on the top and/or the bottom of the band a luminous strip making it possible to identify the exact state of functioning (open or closed) of the electromagnetic lock when a light source is received inside the band, for example when the electronic suction pad, in which a light source is located, is covered by the band profile.

7. An assembly for opening/closing an access, comprising an openable part mounted to be movable in relation to a door frame, the openable part, for example a door (P), being able to close the access defined by the door frame, for example the casing (D) of the door, or open it, and a device forming an electromagnetic lock, comprising two elements, a counter plate (1) and an electromagnetic suction pad (2), one of the two elements being fixed to one out of the openable part and door frame and the other of the two elements being fixed to the other of the openable part and the door frame, characterised in that means (81; 100) are provided for damping the shock which are designed to dampen a shock applied to the openable part, in particular the door, in the opposite direction of the electromagnetic force attracting the two elements of the lock to one another, the arrangement being such that at least a portion of the force induced by the shock on the openable part does not affect the connection between the counter plate (1) and the suction pad (2).

8. The assembly according to claim 7, characterised in that it comprises a band profile (3) with a longitudinal transverse section substantially in the form of a U comprising two lateral branches (32i, 32e) internal and external branches respectively and a base (40) forming a peak extending between the two lateral branches, the band profile being fixed to the openable part, in particular a door, in particular at the opposite free end edge at the edge of the door by which it is fixed in a pivoting manner, one element of the two constituent elements of the electromagnetic lock, namely the counter plate (1) and the electronic suction pad, being fixed to the band profile, the arrangement being such that at least a portion of the force induced by the shock on the band does not affect the element of the electromagnetic lock fixed to the band.

9. The assembly according to claim 7, characterised in that the arrangement is such that during the application of a shock to the band, the damping means, at least for an interval of time, dampens the displacement of the band profile outside the element of the lock secured to the band profile, whereas the element of the lock fixed to the band remains fixed during said interval of time.

10. The band profile according to claim 1, characterised in that the dimension, form and geometry of the recess or of each recess are such that the user only has available as a force application surface (37i, 37e) for pulling the door towards him a surface which can only make contact with a surface that is smaller than that of distal phalanges (50), in particular reduced by half.

11. The band profile according to claim 1, characterised in that the transverse plate (41) is fixed to part of the profile with which the base (40) and the lateral branches (32i, 32e) are in a single piece by irreversibly clipping its end into the clip cavities arranged on the respective inner surfaces of the lateral branches.

12. The band profile according to claim 1, characterised in that the arrangement is such that the element of the lock fixed to the band profile can be displaced in an elastic manner towards the transverse plate (41) by a distance between 1 mm and 7 mm, preferably between 2 and 5 mm, from the effect of a thrust force of 15 to 20 Newtons, in particular compressing elastic means (82) tending to push away the element of the transverse plate, for example by compressing an elastomer sponge (82) arranged between the element of the lock and the transverse plate (41).

13. The band profile according to claim 6, characterised in that the light source is received in the suction pad (2) of the electromagnetic lock, the arrangement being such that when the door is closed the suction pad is received in the band profile (3) and the light emitted by the light source from the suction pad propagates through the end plug or plugs and gives an indication of the open/closed state of the door.

14. The band profile according to claim 1, characterised in that the element of the lock fixed to the band is the counter plate (1).

15. A system for closing/opening a door, comprising an openable part, for example a door (P), to which a band profile (3) according to claim 1 is secured and a door frame, for example a door casing (D), to which the other element of the electromagnetic lock is secured which is not fixed to the band profile.

16. The band profile according to claim 2, characterised in that the transverse plate (41) is fixed to part of the profile with which the base (40) and the lateral branches (32i, 32e) are in a single piece by irreversibly clipping its end into the clip cavities arranged on the respective inner surfaces of the lateral branches.

17. The band profile according to claim 3, characterised in that the transverse plate (41) is fixed to part of the profile with which the base (40) and the lateral branches (32i, 32e) are in a single piece by irreversibly clipping its end into the clip cavities arranged on the respective inner surfaces of the lateral branches.

18. The band profile according to claim 5, characterised in that the transverse plate (41) is fixed to part of the profile with which the base (40) and the lateral branches (32i, 32e) are in a single piece by irreversibly clipping its end into the clip cavities arranged on the respective inner surfaces of the lateral branches.

19. The band profile according to claim 1, characterised in that the arrangement is such that the element of the lock fixed to the band profile can be displaced in an elastic manner towards the transverse plate (41) by a distance between 1 mm and 7 mm, preferably between 2 and 5 mm, from the effect of a thrust force of 15 to 20 Newtons, in particular compressing elastic means (82) tending to push away the element of the transverse plate, for example by compressing an elastomer sponge (82) arranged between the element of the lock and the transverse plate (41).

20. The band profile according to claim 3, characterised in that the arrangement is such that the element of the lock fixed to the band profile can be displaced in an elastic manner towards the transverse plate (41) by a distance between 1 mm and 7 mm, preferably between 2 and 5 mm, from the effect of a thrust force of 15 to 20 Newtons, in particular compressing elastic means (82) tending to push away the element of the transverse plate, for example by compressing an elastomer sponge (82) arranged between the element of the lock and the transverse plate (41).
